(19) United States
(12) Patent Application Publication
(10) Pub. No.: US 2010/0119019 A1
(43) Pub. Date: May 13, 2010

(54) RECEIVING APPARATUS AND METHOD, PROGRAM AND RECORDING MEDIUM USED FOR THE SAME

(76) Inventor: Shinya ITO, Osaka (JP)

Correspondence Address: BIRCH STEWART KOLASCH & BIRCH, PO BOX 747, FALLS CHURCH, VA, 22040-0747, US

(21) Appl. No.: 12/537,626

(22) Filed: Aug. 7, 2009

(30) Foreign Application Priority Data
Nov. 11, 2008 (JP) 2008-288759

(51) Int. Cl. H04B 1/18; H04L 27/28

(52) U.S. Cl. 375/344

(57) ABSTRACT

A receiving apparatus according to the present invention includes a filter control portion 115 that variably controls cutoff frequencies of analog filters 203a, 203b incorporated in the tuner 101 based on a received condition of the received signal.

### CROSS-REFERENCE TO RELATED APPLICATIONS

This application is based on Japanese Patent Application No. 2008-288759 filed in Japan on Nov. 11, 2008, the entire contents of which are hereby incorporated by reference.

### BACKGROUND OF THE INVENTION

1. Field of the Invention

The present invention relates to a receiving apparatus and method for receiving a digital signal that is broadcasted or communicated by using the Orthogonal Frequency Division Multiplexing (hereinafter, called OFDM), and more particularly, to a technology that alleviates a characteristic requirement for an analog filter which is incorporated in a tuner.

2. Description of Related Art

In recent years, service that employs a mobile terminal which receives multimedia information by using an infrastructure for digital broadcasting and communication has been widespread. In achieving such service, a receiving apparatus that curbs power consumption and is excellent in the minimum receiving sensitivity and anti-interference is necessary. Besides, in the reception with a mobile terminal, because there is a drawback that a transmission-path condition easily changes compared with stationary reception, it is necessary to raise transmission-path equalization performance as high as possible. For example, because the OFDM is excellent in frequency efficiency and uses a plurality of narrow-band subcarriers, it is possible to perform sufficient transmission-path equalization even in a multi-path fading environment compared with a single-carrier method, which results in stable reception even with a mobile terminal.

FIG. 4 is a block diagram showing a conventional example of a receiving apparatus. In FIG. 4, components indicated by reference numbers are: an antenna 100, a tuner 101, an analog/digital converter (ADC) 102, a fast Fourier transform portion (FFT) 103, a equalization process portion 104, a demapping portion 105, a deinterleave and forward error correction (FEC) portion 106, and an automatic gain control (AGC) portion 117.

In light of the fact that broadcasting bands are different from country to country, many of the tuners 101 interact with a plurality of bands. For example, DVB-H (Digital Video Broadcasting-handheld) that is a mobile broadcasting standard in Europe is required to deal with each band of 5 MHz, 6 MHz, 7 MHz, and 8 MHz.

Accordingly, in a general receiving apparatus, by using a controller (not shown in FIG. 4) incorporated in an application processor 130 or in a demodulator 120, the pass bands of analog filters 203a, 203b (generally, called a baseband filter or an intermediate frequency (IF) filter) are switched only one time depending on a broadcasting band at a start time of reception. By the switching control of the filter output band, it becomes possible to curb an adjacent interference wave and increase anti-interference, while maintaining a desired waveform.

Besides, in a general receiving apparatus, by controlling the gain of a low noise amplifier (LNA) 201 by means of the AGC 117, the output signal from the tuner 101 is so controlled to an appropriate level as to prevent the input signal to the ADC 102 from being saturated.

As described above, in a conventional digital broadcast receiving apparatus that uses the OFDM, a signal that is filtered by the tuner 101 in accordance with an appropriate broadcasting band is output to the demodulator 120. Accordingly, in principle, the filtering by the tuner 101 does not influence the equalization process performed by the equalization process portion 104 that is incorporated in the demodulator 120. As described above, in the conventional technique, it is ensured that a signal which is least influenced by an interference wave is always output from the tuner 101 to the demodulator 120. On the other hand, an anti-fading characteristic that is a feature of digital broadcasting which employs the OFDM is not used for removing an interference wave.

Here, a conventional technology disclosed in JP-A-2005-109936 (hereinafter, called the patent document 1) relates to a DAB (Digital Audio Broadcasting) receiver that is in conformity with the DAB which is a digital audio broadcasting standard; and a demodulation circuit that includes a band change control means which changes the band width of a digital filter that applies filtering to a digital received signal after AD conversion depending on a detection condition of a receiving channel is disclosed and proposed. Specifically, in the above DAB receiver, the band width of a digital filter is variably controlled between the time of a channel search and the time of a channel reception of a desired wave, so that a receiver which has a high anti-interference is achieved with ease. This conventional technology takes advantage of a feature of the DAB that in a DAB receiver, it is possible to achieve a receiver that has an adjacent interference ratio which is obtained in a channel search performed under the condition with no interference wave or a low adjacent interference ratio and is higher than an adjacent interference ratio which is obtained in a channel search that is performed under the condition with a high adjacent interference ratio.

However, in the conventional technology disclosed in the patent document 1, the band width of only a digital filter is variably controlled; accordingly, it is impossible to alleviate the characteristic requirement for an analog filter. Besides, in the conventional technology disclosed in the patent document 1, attention is focused on only the interference removal ratio before and after a channel search, and it is not suggested nor set forth that further improvement in interference removal ratio is achieved by selecting an appropriate filter characteristic depending on a transmission-path condition.

As described above, in the conventional technology disclosed in the patent document 1, it is impossible to achieve a receiving apparatus that performs appropriate filter control easily and surely depending on a transmission-path condition.

### SUMMARY OF THE INVENTION

The present invention has been made to deal with the conventional problems, and it is an object to provide a receiving apparatus and method that achieve both higher anti-interference and higher receiving sensitivity.

To achieve the above object, a receiving apparatus according to the present invention includes: a tuner that extracts a desired frequency component from a received signal; a demodulator that applies demodulation and equalization processes using Orthogonal Frequency Division Multiplexing to an output signal from the tuner; and a filter control portion that variably controls a cutoff frequency of an analog filter incorporated in the tuner based on a received condition of the received signal.

According to the present invention, the cutoff frequency of the analog filter incorporated in the tuner is controlled depending on a transmission-path condition; thus it is possible to provide a receiving apparatus and method that not only improve anti-interference but also are excellent in receiving sensitivity and multi-path fading characteristic as well.

Other features, elements, steps, advantages, and characteristics will be more apparent from the following detailed description of preferred embodiments and the attached drawings in connection with the description.

### BRIEF DESCRIPTION OF THE DRAWINGS

FIG. 1 is a block diagram showing an embodiment of a receiving apparatus according to the present invention.

FIG. 2 is a view showing an example and effects of filter control.

FIG. 3 is a view showing influence due to filter control.

FIG. 4 is a block diagram showing a conventional example of a receiving apparatus.

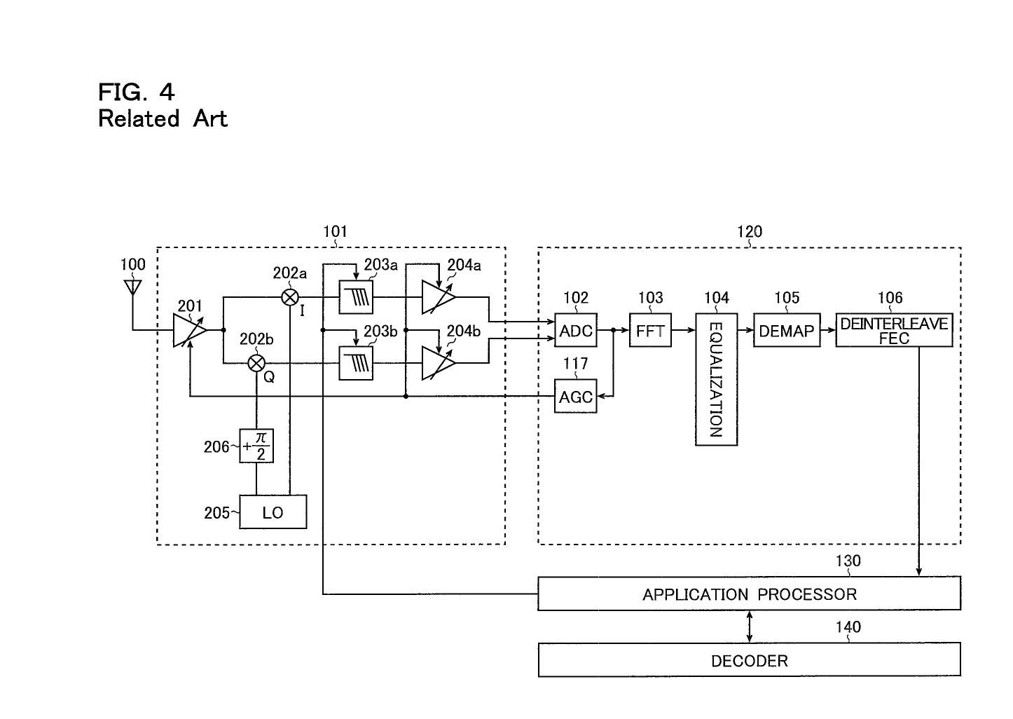

### DETAILED DESCRIPTION OF PREFERRED EMBODIMENTS

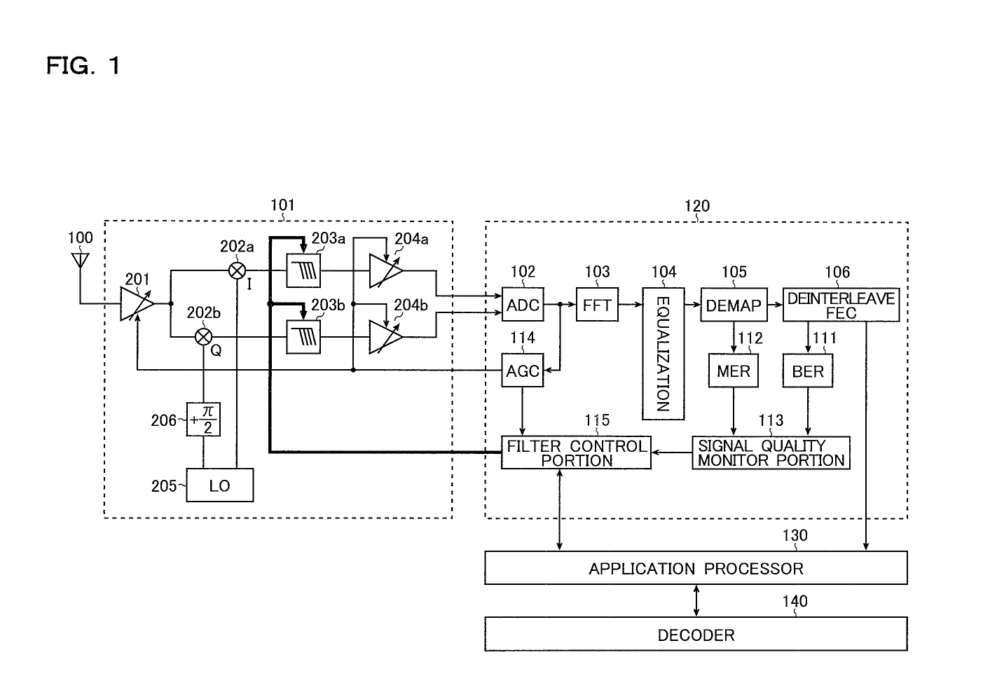

FIG. 1 is a block diagram showing an embodiment of a receiving apparatus according to the present invention. As shown in FIG. 1, the receiving apparatus according to the present invention includes: an antenna 100; a tuner 101; a demodulator 120; an application processor 130; and a decoder 140.

The tuner 101 is a means that extracts a desired frequency component from a received signal (a digital broadcasting signal) input from the antenna 100 and includes: a LNA (low noise amplifier) 201; mixers 202a, 202b; analog filters 203a, 203b (generally, called a base band filter or an IF (intermediate frequency) filter); base band PGAs (programmable gain amplifier) 204a, 204b; a local oscillator 205; and a π/2 phase shifter 206.

The demodulator 120 is a means that applies demodulation and equalization processes using the OFDM to an output signal from the tuner 101 and includes: an analog/digital converter 102 (hereinafter, called an ADC 102); a fast Fourier transform portion 103 (hereinafter, called a FFT portion 103); an equalization process portion 104; a demapping portion 105; a deinterleave and forward error correction portion 106 (hereinafter, called a deinterleave and FFC portion 106); a bit error rate measurement portion 111 (hereinafter, called a BER measurement portion 111); a modulation error rate measurement portion 112 (hereinafter, called a MER measurement portion 112); a signal quality monitor portion 113; an automatic gain control portion 114 (hereinafter, called an AGC portion 114); and a filter control portion 115.

The application processor 130 performs communication with the demodulator 120. Besides, if necessary, demultiplexing and decoding may be implemented conforming to the MPEG2-TS, the H.264 or the like by the decoder 140.

Here, an implementer that performs operation for controlling the signal quality monitor portion 113 and the filter control portion 115 may be composed of a dedicated hard-wired logic or of a microcontroller (not shown in FIG. 1) incorporated in the demodulator 120. The signal quality monitor portion 113 and the filter control portion 115 are each composed of a plurality of circuit components. In the description below, unless otherwise specified, the plurality of circuit components may be a unit of circuit elements which are respectively specified for independent functions or may include: hardware such as a multi-purpose processor (a processing apparatus) and the like; and a program that forces the hardware to operate to implement each function described below. In the latter case, the circuit components are composed by a combination of the hardware and the program. In other words, a program for the above filter control is executed by a processor, so that the processor functions as the signal quality control portion 113 and the filter control portion 115.

The above filter control program is able to be stored in recording mediums readable by a computer such as removable recording mediums like a CD-ROM (Compact Disc Read Only Memory) disc, a flexible disc (FD), and a MO (magneto-optical) disc, a fixed recording medium like a hard disc, or semiconductor recording mediums like a flash memory and distributed, and also able to be distributed via a communication network such as the Internet or the like by using a cable or radio electric communication means.

In the receiving apparatus having the above structure, a signal input through the antenna 100 is converted into an IF (Intermediate Frequency) signal having a predetermined level by the tuner 101, and then input into the ADC 102 of the demodulator 120.

The above processing by the tuner 101 is described in detail. The LNA 201 amplifies an input signal from the antenna 100 and outputs the amplified signal to the mixers 202a, 202b. The mixers 202a, 202b perform frequency conversion by multiplying an amplified signal input from the LNA 201 and a local oscillation signal that is directly input from the local oscillator 205 or via the π/2 phase shifter 206, thereby generating I and Q signals that are shifted in phase by π/2. The analog filters 203a, 203b apply filtering to the I and Q signals input from the mixers 202a, 202b using the broadcasting band as a pass band in principle, thereby removing an adjacent interference wave. The base band PGAs 204a, 204b amplify output signals from the analog filters 203a, 203b and output the amplified signals to the ADC 102 of the demodulator 120.

The analog filters 203a, 203b are each generally composed of a low pass filter such as a Chebyshev filter or the like. If the degree of the filter is set high, it is possible to achieve a filter that has a sharp cutoff, at the cost of the increase in area and power consumption. Besides, the analog filters 203a, 203b are so structured as to switch capacitors included therein, perform variable control of each cutoff frequency, and change each pass band.

The LNA 201 and the base band PGAs 204a, 204b are so structured that each gain is variably controlled based on a gain control signal from the AGC 114, so that the input signal to the ADC 102 is not saturated and the SNR (Signal to Noise Ratio) at the time of demodulation process in the demodulator 120 becomes maximum.

Next, the demodulation process by the demodulator 120 is described in detail. The ADC 102 converts an analog signal input from the tuner 101 in to a digital signal. The FFT 103 demodulates a digital signal input from the ADC 102 using the OFDM. The equalization process portion 104 corrects the amplitude and phase of the OFDM demodulation signal by using the SP (Scattered Pilot) signal and the like disposed between the subcarriers. The demap portion 105 demaps the corrected signal obtained by the equalization process portion 104 on an IQ plane. The deinterleave and FEC portion 106 applies a deinterleave process and a forward error correction process to the signal obtained by the demap portion 105. The processed signal is usually transmitted to the application processor 130 as a MPEG2-TS, undergoes a decoding process by the decoder 140 and used for reproduction of an image.

The BER measurement portion 111 calculates a BER by counting the number of blocks the errors of which are corrected by the deinterleave and FEC portion 106 (e.g., a Reed-Solomon decoding portion included therein). Here, the BER is a bit error rate which represents a ratio of error bits to all received bits.

The MER measurement portion 112 calculates a MER from a constellation that is obtained by the demap portion 105. Here, the MER is a modulation error ratio, and specifically, represents by a power ratio an ideal signal point vector and an error vector which is obtained by calculating how many vector errors a demapped complex signal point vector has with respect to the ideal signal point. In other words, the MER is a SNR that is obtained from a constellation after demapping.

The signal quality monitor portion 113 monitors the grade of signal quality based on a BER obtained by the BER measurement portion 111 and a MER obtained by the MER measurement portion 112 and transmits the result to the filter control portion 115. According to this structure, it becomes possible to control the filter characteristics of the analog filters 203a, 203b by using the BER and MER as indexes of received signal quality.

The filter control portion 115 variably controls cutoff frequencies of the analog filters 203a, 203b that are incorporated in the tuner 101 based on received conditions (received signal intensity and received signal quality) of a received signal. In detail, based on the received conditions of the received signal, the filter control portion 115 determines which one of anti-interference and receiving sensitivity is to be given priority and variably controls the cutoff frequencies of the analog filters 203a, 203b to switch operations for making the pass bands of the analog filters 203a, 203b narrower than or equal to usual widths.

The filter control portion 115 receives an instruction from a controller (not shown) incorporated in the demodulator 120 or an instruction from the application processor 130 that bypasses the above controller and is externally connected to the demodulator 120, sets a register value that is stored in the filter control portion 115 or switches programs, thereby variably controlling the cutoff frequencies of the analog filters 203a, 203b.

Hereinafter, a specific example of the filter control relating to the present invention is described in detail.

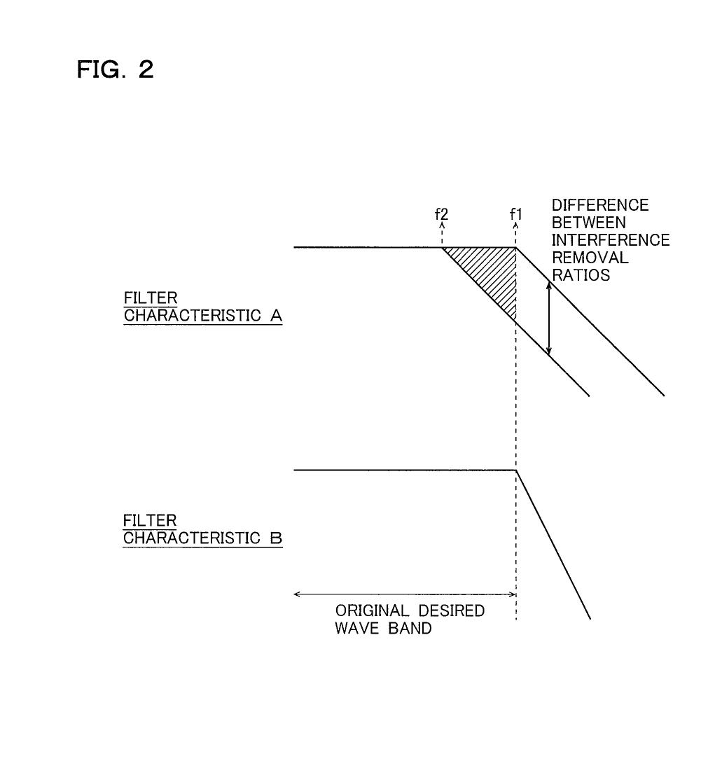

As described in the paragraphs for the background of the present invention, in the conventional receiving apparatus, in removing an interference wave, it is impossible to use the strong anti-fading characteristic that is a feature of the digital broadcasting which uses the OFDM. In other words, the conventional receiving apparatus does not use the fact that even if a signal (see FIG. 2) that falls in the pass bands of the analog filters 203a and 203b which are intentionally made narrower than the broadcasting band is input into the demodulator 120, it can be possible to receive the signal depending on the extent of sensitivity deterioration caused by an error in the equalization process. This problem is described in detail with reference to FIG. 2.

For example, assuming that to output all desired-wave bands of a received broadcast with no attenuation, the filter characteristic must be so controlled that the cutoff frequency becomes f1. In this case, if the filter characteristic is so controlled that the cutoff frequency becomes f2 (<f1), the desired wave attenuates by a triangular-shaped region indicated by slanted lines in FIG. 2 compared with a case where the filter characteristic is so controlled that the cutoff frequency becomes f1.

However, as is seen from the difference in the interference removal ratios shown in FIG. 2, if the filter characteristic is so controlled that the cutoff frequency becomes f2, it is possible to attenuate an interference wave more than the case where the filter characteristic is so controlled that the cutoff frequency becomes f1. Accordingly, if the influence due to the attenuation (the triangular-shaped region indicated by the slanted lines) of a desired wave is small, it is possible to improve the anti-interference.

In analog broadcast receiving apparatuses and digital broadcast receiving apparatuses that use a single carrier which is not in conformity with the OFDM, it is difficult to suitably demodulate a signal subjected to the above attenuation to a receivable level. However, in digital broadcast receiving apparatuses that use the OFDM, for example, in digital broadcast receiving apparatuses which are in conformity with standards such as ISDB-T (Integrated Services Digital Broadcasting-Terrestrial) and DVB-H, it is possible to recover even a signal subjected to the above attenuation to a sufficiently receivable level by performing a frequency-axis direction equalization process by means of a SP signal disposed between the subcarriers.

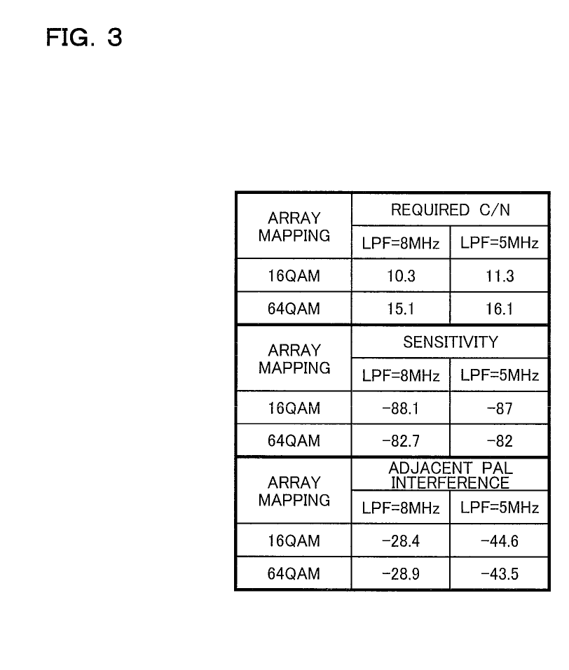

Of course, although the receiving sensitivity of a signal deteriorates by an equalization error in applying an equalization process to the attenuated amount (the triangular-shaped region indicated by the slanted lines) of a desired wave, the extent of the deterioration is actually measured so small as shown in FIG. 3. The actual measurements shown in FIG. 3 represent performance comparison results in a case where the cutoff frequencies f1 and f2 are set to 8 MHz and 5 MHz, respectively while the upper-limit frequency of the broadcasting band is 8 MHz.

If the sensitivity deterioration is so small as shown in FIG. 3, because it is possible not only to continue the receiving operation of broadcasting signals without any trouble but also sufficiently attenuate an interference wave even if a desired wave is attenuated by the analog filters 203a and 203b, it is possible to curb the sensitivity deterioration caused by the interference wave. Accordingly, only when especially anti-interference is required, a signal that falls in a band narrower than the original broadcasting band is intentionally output from the tuner 101 and the filter characteristic is so switched as to raise the capability to curb an interference wave, thus it becomes possible to maximize the anti-interference.

Besides, because it is possible to alleviate the characteristic requirement for the filters 203a, 203b incorporated in the tuner 101 by the above switch control of the filter characteristic, it becomes possible to achieve size reduction and low power consumption. For example, it becomes possible to provide a receiving apparatus that has the same anti-interference by using a low-degree filter that has the filter characteristic A shown in FIG. 2 without using a high-degree filter that has the filter characteristic B shown in FIG. 2.

The present invention is made taking the above study into account. Hereinafter, functions and effects of the filter control performed in a receiving apparatus according to the present invention are schematically described. It is assumed that there is a receiving apparatus in which the receiving sensitivity is −97 dBm and the D/U ratio that is an index of anti-interference is −30 dB in a case where, for example, the cutoff frequencies of the analog filters 203a, 203b are so controlled that a pass band equal to a broadcasting band is obtained. Besides, it is assumed that in this receiving apparatus, the receiving sensitivity becomes −95 dBm and the D/U becomes −45 dB if the cutoff frequencies of the analog filters 203a, 203b are so controlled that the pass band becomes narrower than the broadcasting band.

In such a receiving apparatus that receives a digital broadcast which uses the OFDM, because the demodulator 120 is equipped with the equalization process portion 104, the influence of an advantage (increase in the anti-interference) can be much greater than a disadvantage (deterioration in the receiving sensitivity) depending on an extent to which the pass bands of the analog filters 203a and 203b are narrowed.

However, as is understood from the above example, if the cutoff frequencies of the analog filters 203a, 203b are so set in stationary fashion that the pass bands become narrower than the broadcasting band, deterioration in the receiving sensitivity constantly occurs although the deterioration is so small as 2 dB. This deterioration in the receiving sensitivity is equivalent to a deterioration in the SNR required for error-free reception with respect to the demodulator 120; accordingly, there is a concern that the receiving rate can drop in a multi-path fading environment and the like.

Accordingly, to raise the receiving rate in an actual use environment, it is important to so control each cutoff frequency as not to narrow the pass bands of the analog filters 203a, 203b except when it is determined that the level of an interference wave is large, or the D/U is severer than −30 dB in the above example. For this purpose, filter control described below is effective.

Generally, anti-interference becomes important mainly in a case where the level of an interference wave is high as in the time of reception near an analog broadcasting tower. This is because the influence of multi-path fading becomes great in an actual use environment when the level of an interference wave is low, but the D/U is almost the same.

Accordingly, in the simplest filter control technique, it is possible that as an index that represents a receiving condition of the tuner 101, a gain control signal (hereinafter, called a RFAGC: Radio Frequency Automatic Gain control) of a radio frequency amplifier (the LNA 201 in FIG. 1) incorporated in the tuner 101, or a received-signal strength detection signal (hereinafter, called a RSSI: Received Signal Strength Indicator) that represents the strength of a received signal is monitored; only when it is determined based on a result of the monitor that there is a large interference wave, respective cutoff frequencies of the analog filters 203a, 203b are so variably controlled as to narrow that the pass bands of the analog filters 203a, 203b incorporated in the tune 101.

The above filter control technique is described in detail. The filter control portion 115 receives at predetermined intervals information (a RFAGC signal or a RSSI signal used for the gain control of the tuner 101) on the signal strength of a received signal from the AGC portion 114; and infers whether or not there is a large interference wave by comparing the signal value and a predetermined threshold value. If the filter control portion 115 determines that the interference wave is large, the filter control portion 115 variably controls the cutoff frequencies of the analog filters 203a, 203b to make the pass bands of the analog filters 203a, 203b narrower than usual; if the filter control portion 115 determines that the interference wave is not large, the filter control portion 115 variably controls the cutoff frequencies of the analog filters 203a, 203b to make the pass bands of the analog filters 203a, 203b wide as usual. Here, the above threshold value may be stored in the filter control portion 115 in advance.

As a timing of the filter control, at the time the signal value of the RFAGC signal or of the RSSI signal exceeds the predetermined threshold value, the cutoff frequencies may be immediately switched, or the comparison determination are performed a plurality of times within a predetermined time; when the number of cases where the signal value of the RFAGC signal or of the RSSI signal exceeds half of the total number of comparisons, the cutoff frequencies may be switched.

Besides, the threshold value that is referred to in narrowing the pass bands of the analog filters 203a, 203b and the threshold value that is referred to in widening the pass bands of the analog filters 203a, 203b may be made so different from each other as to allow the thresholds values to have hysteresis. According to this structure, because it is possible to prevent the employed filter characteristic from being frequently switched when the transmission-path condition is sharply changing, it is possible to achieve a stable receiving operation. Especially in the case where the pass bands of the analog filters 203a, 203b incorporated in the tuner 101 are set narrower than usual, there is a concern that the above filter control deteriorates the receiving performance to the contrary in a multi-path fading environment; however, for example, if the above threshold values have hysteresis to widen the pass bands of the analog filters 203a, 203b in an easier way than a way to narrow them, it becomes easier to deal with performance deterioration factors (multi-path fading and the like) other than an interference wave.

There is also a technique below as the filter control to curb the sensitivity deterioration to the minimum while setting the pass bands of the analog filters 203a, 203b narrower than the broadcasting band. In the AGC portion 114, as AGC information for automatic control of the total gain of the tuner 101, a gain control signal (hereinafter, called a BBAGC (Broad Band Automatic Gain Control) signal) of an intermediate-frequency amplifier (in the example in FIG. 1, the base band PGAs 204a, 204b) is generated besides the above RSSI signal and the RFAGC signal; accordingly, it is possible to infer the input signal strength of a desired wave input into the tuner 101 based on a sum (a total gain value) of the RFAGC signal and the BBAGC signal and on the RSSI signal.

The filter control portion 115 receives the input signal strength inferred by the AGC portion 114; if the filter control portion 115 determines that the input signal strength of the desired wave input into the tuner 101 is small and a higher receiving sensitivity is necessary, the filter control portion 115 variably controls the cutoff frequencies of the analog filters 203a, 203b not to narrow the pass bands of the analog filters 203a, 203b. Besides, here, the filter control portion 115 compares signal strength information (the RFAGC signal or the RSSI signal) on the signal strength of the received signal and the predetermined threshold value based on the comparison result; if the filter control portion 115 determines that it is necessary to give priority to prevention of deterioration in the receiving sensitivity, the filter control portion 115 variably controls the cutoff frequencies of the analog filters 203a, 203b not to narrow the pass bands of the analog filters 203a, 203b.

In other words, the filter control portion 115 monitors the sum (the total gain value) of the RFAGC signal and the BBAGC signal; based on a result of a comparison of the signal value and the predetermined threshold value, if the filter control portion 115 determines that the input signal strength of the desired wave is small, the filter control portion 115 makes the pass bands of the analog filters 203a, 203b wide as usual regardless of the size of the interference wave; based on the result of the comparison of the signal value and the predetermined threshold value, if the filter control portion 115 determines that the input signal strength of the desired wave is not small, as described above, depending on the size of the interference wave, the filter control portion 115 variably controls the cutoff frequencies of the analog filters 203a, 203b to switch operations for making the pass bands of the analog filters 203a, 203b narrower than or equal to usual widths. By performing such filter control, it is possible to match the pass bands of the analog filters 203a, 203b with the broadcasting band with no delay without narrowing the pass bands of the analog filters 203a, 203b not only in a case where it is inferred that the interference wave is not large but also in a case where it is inferred that the desired wave is small; accordingly, it becomes possible to curb deterioration in the receiving sensitivity to the minimum.

The threshold value that is compared with the total gain value may be stored in the filter control portion 115 in advance and may also be given hysteresis as described above.

Besides, instead of the use of the above signal strength information, there is also a technique to perform the filter control by using signal quality information. In this case, the filter control portion 115 tries periodically and only for a short time span to narrow the pass bands of the analog filters 203a, 203b. The MER measurement portion 112 outputs the MERs (or SNRs) measured during the trial and non-trial (the time of usual operation) times as the signal quality information to the filter control portion 115 via the signal quality monitor portion 113. The filter control portion 115 compares the MERs in the time of trials and the MERs in the time of non-trials (the time of usual operation) and counts the number of improved MERs. Then, the filter control portion 115 compares the count value (the number of improved MERs) and a predetermined threshold value; if the filter control portion 115 determines that the former is larger than the latter and improvement in the signal quality is expected, the filter control portion 115 switches the current values of the pass bands of the analog filters 203a, 203b to trial values and performs the filter control to inverse the filter characteristic in the trial time and the filter characteristic in the non-trial time. To the contrary, if it is determined that the former is smaller than the latter and improvement in the signal quality is not expected, the pass bands of the analog filters 203a, 203b are kept at the current values.

In other words, in the above comparison and determination, if it is determined that the former is larger than the latter, thereafter it is tried periodically and only for a short time span to widen the pass bands of the analog filters 203a, 203b; in the non-trial time (the time of usual operation), the cutoff frequencies are so set as to narrow the pass bands of the analog filters 203a, 203b. Here, in the filter control portion 115, like in the foregoing description, the MERs in the time of trials and the MERs in the time of non-trials (the time of usual operation) are compared with each other and it is determined whether or not the number of improved MERs is large than the predetermined threshold value. If it is determined that the former is larger than the latter and improvement in the signal quality is expected, the current values of the pass bands of the analog filters 203a, 203b are switched to the trial values, and the filter characteristic in the trial time and the filter characteristic in the non-trial time are inversed again. To the contrary, if it is determined that the former is smaller than the latter and improvement in the signal quality is not expected, the pass bands of the analog filters 203a, 203b are kept at the current values. Also thereafter, the above trial operation is repeated until the receiving operation is completed. The threshold value that is compared with the number of improved MERs may be stored in the filter control portion 115 in advance and may also be given hysteresis as described above.

Besides, as the above signal quality information, the BER may be used instead of the MER. However, the time required for obtaining the BER is longer than the time required for obtaining the MER. Accordingly, to use the BER as the signal quality information, it is desirable to set the above threshold value to a small value instead of the using of the MER as the signal quality information. According to such structure, because the number of trials required for the inverse of the filter characteristic decreases, it is possible to sufficiently deal with a sharp change in the signal quality caused by a sudden interference wave due to reflection and the like.

Although not shown in FIG. 1, there is also a case where the filter control portion 115 uses the application processor 130 to communicate with GPS receiving portions that are incorporated in mobile phone terminals, car navigation systems and the like and obtains information on a current position of the receiving apparatus; and variably controls the cutoff frequencies of the analog filters 203a, 203b to narrow or widen the pass bands of the analog filters 203a, 203b by referring to a database in which a relationship between the current positions and the strengths of interference waves is contained. For example, it becomes possible to perform more appropriate filter control by adjusting the above threshold value in accordance with the current position of the receiving apparatus. In employing such structure, the above database may be stored in a storage portion (an external storage device such as a semiconductor memory, a hard disc drive or the like) not shown in FIG. 1 or may be obtained from the outside via a network such as the Internet or the like.

In the above embodiments, a structural example in which the present invention is applied to a direct-conversion receiving apparatus is described. However, the present invention is not limited to this, and it is possible to widely apply the present invention to receiving apparatuses which employ another architecture.

Besides, in the above embodiments, a structural example in which the present invention is applied to a receiving apparatus that receives broadcasting signals. However, the present invention is not limited to this, and it is possible to widely apply the present invention to receiving apparatuses that receive communication signals.

In addition, besides the above embodiments, it is possible to add various modifications to the structure of the present invention without departing from the spirit of the present invention.

In other words, although the preferred embodiments of the present invention are described, the present invention disclosed is able to be modified in various ways, and it is apparent to those skilled in the art that it is possible to employ various embodiments different from the above specific structures. Accordingly, the following claims intend to read on any modifications of the present invention within the technical scope without departing from the spirit and technical concept of the present invention.

As for the industrial applicability of the present invention, in a receiving apparatus and method for receiving a digital broadcast and communication that use the OFDM, the present invention is a useful technology to alleviate the characteristic requirement for an analog filter incorporated in a tuner and increase both anti-interference and receiving sensitivity.

What is claimed is:

1. A receiving apparatus comprising:
a tuner that extracts a desired frequency component from a received signal;
a demodulator that applies demodulation and equalization processes using Orthogonal Frequency Division Multiplexing to an output signal from the tuner; and
a filter control portion that variably controls a cutoff frequency of an analog filter incorporated in the tuner based on a received condition of the received signal.

2. The receiving apparatus according to claim 1, wherein based on a received condition of the received signal, the filter control portion determines which one of anti-interference and receiving sensitivity is to be given priority and variably controls the cutoff frequency of the analog filter to switch operations for making the pass band of the analog filter narrower than or equal to a usual width.

3. The receiving apparatus according to claim 2, wherein the filter control portion monitors a gain control signal of a radio frequency amplifier incorporated in the tuner, or a received-signal strength detection signal that represents the strength of the received signal; if the filter control portion determines based on a result of a comparison of a value of the signal and a predetermined threshold value that there is a large interference wave, the filter control portion variably controls the cutoff frequency the analog filter to make the pass band of the analog filter narrower than usual; if the filter control portion determines that the interference wave is not large, the filter control portion variably controls the cutoff frequency of the analog filter to make the pass band of the analog filter wide as usual.

4. The receiving apparatus according to claim 3, wherein the filter control portion monitors a sum of the gain control signal of the radio frequency amplifier incorporated in the tuner and a gain control signal of an intermediate-frequency amplifier; based on a result of a comparison of a value of the signal and a predetermined threshold value, if the filter control portion determines that a desired wave is small, the filter control portion makes the pass band of the analog filter wide as usual regardless of the size of the interference wave; based on the result of the comparison of the signal value and the predetermined threshold value, if the filter control portion determines that the desired wave is not small, based on the size of the interference wave, the filter control portion variably controls the cutoff frequency of the analog filter to switch operations for making the pass band of the analog filter narrower than or equal to usual widths.

5. The receiving apparatus according to claim 2, wherein the filter control portion periodically performs a trial to switch the current value of the pass band of the analog filter to a trial value different from the current value; based on a comparison result of the number of improved modulation error ratios, signal to noise ratios or bit error rates and a predetermined threshold value, if the filter control portion determines that improvement in signal quality is expected, the filter control portion variably controls the cutoff frequency of the analog filter to switch the current value of the pass band of the analog filter to the trial value; based on the comparison result of the number of improved modulation error ratios, signal to noise ratios or bit error rates and the predetermined threshold value, if the filter control portion determines that improvement in signal quality is not expected, the filter control portion variably controls the cutoff frequency of the analog filter to keep the pass band of the analog filter at the current value.

6. The receiving apparatus according to claim 3, wherein the filter control portion gives hysteresis to the threshold value.

7. The receiving apparatus according to claim 1, wherein the filter control portion receives an instruction from a controller incorporated in the demodulator or an instruction from an application processor that is externally connected to the demodulator, and variably controls the cutoff frequency of the analog filter.

8. The receiving apparatus according to claim 1, wherein the filter control portion obtains information on a current position of the receiving apparatus and variably controls the cutoff frequency of the analog filter by referring to a database in which a relationship between current positions and strengths of interference waves is contained.

9. A program for a receiving apparatus, wherein the receiving apparatus includes:
a tuner that extracts a desired frequency component from a received signal;
a demodulator that applies demodulation and equalization processes using Orthogonal Frequency Division Multiplexing to an output signal from the tuner; and
a processor that implements the program,
wherein the program is implemented by the processor and forces the processor to function as a filter control portion that variably controls a cutoff frequency of an analog filter incorporated in the tuner based on a received condition of the received signal.

10. A recording medium for storing a program for a receiving apparatus, wherein the receiving apparatus includes:
a tuner that extracts a desired frequency component from a received signal;
a demodulator that applies demodulation and equalization processes using Orthogonal Frequency Division Multiplexing to an output signal from the tuner; and
a processor that reads the recording medium and implements the program,
wherein the program is implemented by the processor and forces the processor to function as a filter control portion that variably controls a cutoff frequency of an analog filter incorporated in the tuner based on a received condition of the received signal.

11. A receiving method using a receiving apparatus, wherein the receiving apparatus includes:
a tuner that extracts a desired frequency component from a received signal;
a demodulator that applies demodulation and equalization processes using Orthogonal Frequency Division Multiplexing to an output signal from the tuner,
wherein the receiving method comprises the step of:
variably controlling a cutoff frequency of an analog filter incorporated in the tuner based on a received condition of the received signal.

12. The receiving method according to claim 11, further comprising the step of:
determining which one of anti-interference and receiving sensitivity is to be given priority and variably controlling the cutoff frequency of the analog filter to switch operations for making the pass band of the analog filter narrower than or equal to a usual width.

13. The receiving method according to claim 12, further comprising the step of:
monitoring a gain control signal of a radio frequency amplifier incorporated in the tuner, or a received-signal strength detection signal that represents the strength of a received signal; variably controlling the cutoff frequency the analog filter to make the pass band of the analog filter narrower than usual if it is determined based on a result of a comparison of a value of the signal and a predetermined threshold value that there is a large interference wave; and variably controlling the cutoff frequency of the analog filter to make the pass band of the analog filter wide as usual if it is determined that the interference wave is not large.

14. The receiving method according to claim 13, further comprising the step of:
monitoring a sum of the gain control signal of the radio frequency amplifier incorporated in the tuner and a gain control signal of an intermediate-frequency amplifier; making the pass band of the analog filter wide as usual regardless of the size of the interference wave if it is determined that a desired wave is small based on a result of a comparison of a value of the signal and a predetermined threshold value; and variably controlling the cutoff frequency of the analog filter to switch operations for making the pass band of the analog filter narrower than or equal to usual widths based on the size of the interference wave if it is determined that the desired wave is not small.

15. The receiving method according to claim 12, further comprising the step of:
periodically performing a trial to switch the current value of the pass band of the analog filter to a trial value different from the current value; variably controlling the cutoff frequency of the analog filter to switch the current value of the pass band of the analog filter to the trial value if it is determined that improvement in signal quality is expected based on a comparison result of the number of improved modulation error ratios, signal to noise ratios or bit error rates and a predetermined threshold value; and variably controlling the cutoff frequency of the analog filter to keep the pass band of the analog filter at the current value if it is determined that improvement in signal quality is not expected based on the comparison result of the number of improved modulation error ratios, signal to noise ratios or bit error rates and the predetermined threshold value.

16. The receiving method according to claim 13, wherein hysteresis is given to the threshold value.

17. The receiving method according to claim 11, further comprising the step of:
receiving an instruction from a controller incorporated in the demodulator or an instruction from an application processor that is externally connected to the demodulator, and variably controlling the cutoff frequency of the analog filter.

18. The receiving method according to claim 11, further comprising the step of:
obtaining information on a current position of the receiving apparatus and variably controlling the cutoff frequency of the analog filter by referring to a database in which a relationship between current positions and strengths of interference waves is contained.
